(19) United States
(12) Patent Application Publication
(10) Pub. No.: US 2017/0241863 A1
(43) Pub. Date: Aug. 24, 2017

(54) MEASUREMENT OF THERMAL EXPANSION OF GLASSES

(71) Applicant: Corning Incorporated, Corning, NY (US)

(72) Inventors: Nicholas Francis Borrelli, Elmira, NY (US); Kenneth Edward Hrdina, Horseheads, NY (US); Galan Gregory Moore, West Henrietta, NY (US); Lisa Anne Tietz Moore, Corning, NY (US)

(21) Appl. No.: 15/425,000

(22) Filed: Feb. 6, 2017

Related U.S. Application Data
(60) Provisional application No. 62/298,533, filed on Feb. 23, 2016.

(51) Int. Cl. G01M 11/02; G01N 25/16; G01N 21/65

(52) U.S. Cl. CPC G01M 11/0285; G01M 11/0207; G01N 21/65; G01N 25/16; G01N 2201/0231

(57) ABSTRACT

Optical techniques for determining thermal properties of materials are described. Optical techniques include Raman scattering and thermal properties include relative length change and coefficient of thermal expansion. Correlations of features of bands observed in the Raman spectra of several glasses with thermal properties of the glasses are demonstrated. The technique provides a convenient method for determining thermal expansion properties of materials.

This application claims the benefit of priority under 35 U.S.C. §119 of U.S. Provisional Application Ser. No. 62/298,533 filed on Feb. 23, 2016 the content of which is relied upon and incorporated herein by reference in its entirety.

### FIELD

This description pertains to characterization of glasses. More particularly, this description relates to measurements of thermal properties of glasses. Most particularly, this description relates to determination of the coefficient of thermal expansion and expansivity slope of glasses using Raman spectroscopy.

### BACKGROUND

Materials having stable properties over a wide temperature range are needed many applications. One example is in lithography, where Extreme Ultraviolet Lithography (EUVL) is emerging as a lithography technology for extending Moore's law to the 22 nm node and below for MPU/DRAMs [MPU—Micro Processing Unit & DRAM—Dynamic Random Access Memory). The scanners needed to support EUV lithography have been developed and are currently in use on a limited scale to demonstrate the potential of the technology. Key components of EUVL scanners include reflective optics for directing and controlling exposure light from an EUV source to enable patterning of features on silicon wafers. The reflecting optic elements typically include a substrate with a series of coating layers. Due to the short wavelength of EUV exposure light (e.g. 13.5 nm) and the high powers needed for high throughput processing of wafers, significant heating of the reflecting optic elements can occur. In order to avoid distortions in the patterns transferred to the wafers, it is necessary for the reflecting optic elements to maintain constant performance over a wide range of temperature. The requirement for temperature-stable performance has motivated the development of low thermal expansion materials for use as substrate materials for optics in EUVL scanners.

In order to assess the potential of new materials for temperature-stable performance, it is necessary to develop reliable techniques for measuring thermal properties. Important thermal properties include thermal expansion coefficient (CTE) and expansivity slope (CTE slope). Currently, three methods are routinely used to determine CTE and CTE slope of materials: dilatometry, the sandwich seal method (see, for example, U.S. Pat. No. 8,328,417), and an ultrasonic method. Measurements by dilatometry and the sandwich seal method are arduous, slow (measurement times of weeks to months), and require exacting and tedious sample preparations. Ultrasonic methods are more convenient, but provide accurate results only for simple compositions.

There is a need for new methods for determining thermal expansion properties of materials.

### SUMMARY

The present description provides optical techniques for determining thermal properties of materials. Optical techniques include light scattering and Raman scattering. Thermal properties include relative length change (ΔL/L₀), coefficient of thermal expansion (CTE) and the slope of the temperature dependence of the coefficient of thermal expansion (CTE slope). Correlations of features of bands observed in the Raman spectra with thermal properties are demonstrated. The techniques provide a convenient method for determining thermal expansion properties of materials.

The methods include measuring Raman spectra. Features such as the energy, peak intensity, integrated intensity, and linewidth of one or more Raman bands may be correlated with a thermal property of a material. Raman spectra may be measured over a range of temperatures and the temperature dependence of one or more features of one or more bands in the Raman spectrum may be used to develop correlations relating thermal properties to Raman features. The correlations may be used to determine thermal properties of materials.

The present description extends to:
A method of characterizing a glass comprising:

detecting light scattered from a glass; and

determining a thermal property of said glass from said scattered light.

The present description extends to:
A method of characterizing a material comprising:

correlating a spectroscopic property of a material with a thermal property of said material.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 shows the temperature dependence of the relative length change ΔL/L₀ for several titania-silica glasses.

FIG. 2 shows room temperature Raman spectra for several boron-doped titania-silica glasses.

FIG. 3 shows intensity-normalized room temperature Raman spectra for several boron-doped titania-silica glasses.

FIG. 4 shows a correlation of a parameter derived from peak intensities of Raman bands with CTE for boron-doped titania-silica glasses.

FIG. 5 shows images of three glass samples.

FIG. 6 shows an experimental system for measuring Raman spectra of materials as a function of temperature.

FIG. 7 shows the temperature dependence of the Raman spectrum of a glass composition containing 0.4 wt % B₂O₃, 3.0 wt % TiO₂, and 96.6 wt % SiO₂.

FIG. 8 shows the temperature dependence of the Raman spectrum of a glass composition containing 7.4 wt % TiO₂ and 92.6 wt % SiO₂.

FIG. 9 shows the temperature dependence of the Raman spectrum of a glass composition containing 11.0 wt % TiO₂ and 89.0 wt % SiO₂.

FIG. 10 shows the temperature dependence of thermally normalized Raman spectra of a glass composition containing 0.4 wt % B₂O₃, 3.0 wt % TiO₂, and 96.6 wt % SiO₂.

FIG. 11 shows the temperature dependence of thermally normalized Raman spectra of a glass composition containing 7.4 wt % TiO₂ and 92.6 wt % SiO₂.

FIG. 12 shows the temperature dependence of thermally normalized Raman spectra of a glass composition containing 11.0 wt % TiO₂ and 89.0 wt % SiO₂.

FIG. 13 shows the temperature dependence of the frequency of the 930 cm⁻¹ band for three glass samples.

FIG. 14 shows the temperature dependence of the frequency of the 930 cm⁻¹ band for three glass samples.

FIG. 15 shows room temperature Raman spectra of three glass samples in the range from 850 cm⁻¹-1200 cm⁻¹.

FIG. 16 shows room temperature intensity-normalized Raman spectra of three glass samples in the range from 850 cm⁻¹-1200 cm⁻¹.

FIG. 17 shows the temperature dependence of a parameter derived from the Raman spectra of three glass samples.

The embodiments set forth in the drawings are illustrative in nature and not intended to be limiting of the scope of the detailed description or claims. Whenever possible, the same reference numeral will be used throughout the drawings to refer to the same or like feature.

### DETAILED DESCRIPTION

The present description is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

In this specification and in the claims which follow, reference will be made to a number of terms which shall be defined to have the following meanings:

Include,” “includes,” or like terms means encompassing but not limited to, that is, inclusive and not exclusive.

The term “about” references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

Reference will now be made in detail to illustrative embodiments of the present description.

The present description provides a method for measuring thermal properties of materials. The method provides a convenient, fast, and economical procedure for determining thermal properties of materials and is readily adapted to high throughput manufacturing processes. The method is based on optical interrogation of a material and measurement of scattered light from the material. In particular, the intensity of scattered light is measured. In one embodiment, the Raman spectrum of the material is determined and used to determine one or more thermal properties of the material.

The method may be applied to materials in general and is particularly suited to materials for which correlations between an optical or spectroscopic property of the material and a thermal property can be determined. In embodiments of the present description, thermal properties of glasses are considered and titania-silica (TiO₂—SiO₂) glasses (with and without dopants) are emphasized. As described more fully hereinbelow, one or more thermal properties of the titania-silica glasses are determined by Raman spectroscopy. In these embodiments, correlations between features of the Raman spectrum and thermal properties of titania-silica glasses are described.

Thermal properties include the coefficient of thermal expansion and the expansivity slope. The coefficient of thermal expansion may also be referred to herein as “CTE” or “expansivity”. The expansivity slope may also be referred to herein as “CTE slope”. CTE and CTE slope are defined in terms of the linear expansion of a material as follows:

$$CTE = \frac{d ( \frac{Δ L}{{L}_{0}} )}{dT}$$

$$CTE Slope = \frac{d ( CTE )}{dT} = \frac{{d}^{2} ( \frac{Δ L}{{L}_{0}} )}{{dT}^{2}}$$

where the ratio

$$\frac{Δ L}{{L}_{0}}$$

is the relative length change of the material, L₀ is the length of the material at a reference temperature T₀ (25° C.), ΔL=L_{T}−L₀, and L_{T} is the length of the material at temperature T.

Early work on the thermal expansion properties of titania-silica glasses was reported by P. C. Schultz and colleagues. (See, for example, P. C. Schultz and H. T. Smyth in Amorphous Materials (papers presented to the Third International Conference on the Physics of Non-crystalline Solids held at Sheffield University, September 1970), P. W. Douglas and B. Ellis, eds., John Wiley and Sons Ltd. (1972)) Schultz showed that a binary titania-silica glass having 7.40 wt % TiO₂ had a thermal expansion coefficient near zero at room temperature and presented data derived from dilatometry measurements on the relative length change (ΔL/L₀) over a wide temperature range for binary titania-silica glasses having a TiO₂ content in the range from 3 wt % to 10 wt %.

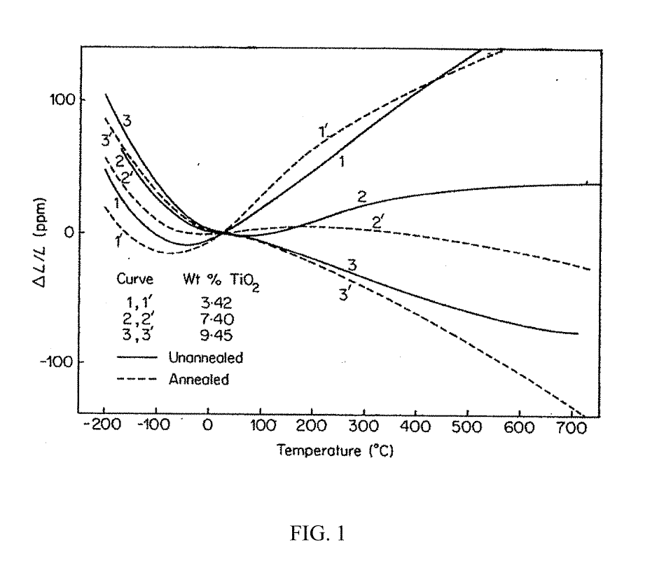

Representative data of Schultz is presented in FIG. 1, which shows ΔL/L₀ as a function of temperature for annealed and unannealed binary titania-silica glasses having TiO₂ content of 3.42 wt % (curve 1 (unannealed) and 1′ (annealed)), 7.40 wt % (curve 2 (unannealed) and curve 2′ (annealed)), and 9.45 wt % (curve 3 (unannealed) and curve 3′ (annealed)). The data are normalized to ΔL/L₀=0 at 25° C. The data show that ΔL/L₀ can be varied over a wide range of values (both positive and negative) by controlling the TiO₂ content of the titania-silica glass. CTE and CTE slope for the titania-silica glasses can be obtained from the data shown in FIG. 1 by taking the first and second derivatives, respectively.

The present disclosure describes optical methods for measuring thermal properties of materials. In certain embodiments, the optical methods include light scattering and the measurement of scattered light intensity. In certain embodiments, the optical methods include Raman spectroscopy and measurement of the Raman spectrum. In certain embodiments, the thermal properties include CTE and/or CTE slope.

In an embodiment of the present methods, CTE and CTE slope are obtained from the Raman spectrum. The method may be applied to binary titania-silica glasses or doped titania-silica glass. The doped titania-silica glass may be a boron-doped titania silica glass. As described more fully in the examples presented hereinbelow, temperature variations in the relative intensities of certain Raman spectral bands in titania-silica glasses (doped or undoped) closely resemble the variations shown for ΔL/L₀ in the data of Schultz shown in FIG. 1. The similarity motivates the methods determining CTE and CTE slope using Raman spectroscopy disclosed herein.

In one embodiment, the method includes measuring the Raman spectrum of a material. The Raman technique may be a conventional, macroscale technique, a micro-Raman technique, or a confocal Raman technique. The Raman technique may be a dispersive technique or a Fourier transform technique. The Raman spectra may be normalized or corrected for baseline effects and other measurement artifacts.

Advantages of the present methods include speed and convenience. Raman measurements, for example, require short measurement times and simple sample preparation procedures. Raman measurements can be performed on samples of virtually any size or shape and no special sample polishing procedures are required. Raman spectroscopy can provide spatially resolved measurements of thermal properties in two or three dimensions and can be applied to glasses having a wide range of composition, including doped and undoped glasses and titania-silica glasses (doped or undoped) over a wide range of TiO₂ content. Potential dopants of titania-silica glasses include B₂O₃, F, OH, alkali metals, alkaline earth metals, and transition metals.

The Raman spectrum may be measured over the range from 100 cm⁻¹-4000 cm⁻¹, or over narrower ranges within the range from 100 cm⁻¹-4000 cm⁻¹. Narrower ranges include the range from 800 cm⁻¹-1300 cm⁻¹, or the range from 850 cm⁻¹-1250 cm⁻¹, or the range from 850 cm⁻¹-1200 cm⁻¹, or the range from 900 cm⁻¹-1200 cm⁻¹, or the range from 850 cm⁻¹-1050 cm⁻¹, or the range from 900 cm⁻¹-1000 cm⁻¹, or the range from 1000 cm⁻¹-1250 cm⁻¹, or the range from 1050 cm⁻¹-1200 cm⁻¹, or the range from 1080 cm⁻¹-1150 cm⁻¹.

The Raman measurements may be performed at room temperature as well as over a range of temperatures. The temperature range of measurement may extend from 0° C. to the melting point of the material, or from 0° C. to 100° C. below the melting point of the material, or from 0° C. to 200° C. below the melting point of the material, or from 0° C. to 300° C. below the melting point of the material. Raman measurements may be performed over the range from 0° C. to 1000° C., or over the range from 0° C. to 800° C., or over the range from 0° C. to 600° C., or over the range from 20° C. to 1000° C., or over the range from 20° C. to 800° C., or over the range from 20° C. to600 ° C. The temperature range of measurement may include temperatures above 100° C., or above 200° C., or above 300° C., or above 400° C., or one or more temperatures in the range from 50° C. to 700° C., or one or more temperatures in the range from 100° C. to 600° C., or one or more temperatures in the range from 200° C. to 500° C.

The method may include generating a calibration curve to correlate features of the Raman spectrum of a material with thermal properties of the material. The calibration may include measuring the Raman spectrum of one or more reference materials having known values of one or more thermal properties (e.g. CTE and/or CTE slope) and correlating the peak intensity, integrated intensity, linewidth, and or frequency of one or more Raman spectral bands with the thermal property. As used herein, peak intensity refers to the maximum intensity of a Raman spectral band and integrated intensity refers to the area of a Raman spectral band. In one embodiment, the method includes correlating the intensity ratio of two Raman bands with ΔL/L₀, CTE or CTE slope.

In one embodiment, the Raman spectral bands used in the determination of CTE and CTE slope of titania-silica glasses are TiO₂-related bands in the approximate spectral regions of 900 cm⁻¹-1000 cm⁻¹ and 1080 cm⁻¹-1150 cm⁻¹. These modes, and possible assignments thereof, have been identified in the prior art. (See, for example, A. Chmel et al., “Vibrational spectroscopic study of Ti-substituted SiO₂”, J. NonCryst. Sol. 146, 213-217 (1992); M. Best et al. “A Raman study of TiO₂—SiO₂ glasses prepared by sol-gel process”, J. Mat. Sci. Lett. 4, 994-998 (1985); D. S. Knight et al., “Raman spectra of gel-prepared titania-silica glasses”; Mat. Lett. 8, 156-160 (1989); and G. Ricchiardi et al., “Vibrational structure of titanium silicate catalyst. A spectroscopic and theoretical approach”, J. Am. Chem. Soc. 123, 11409-11419 (2001).)

As described more fully in the Examples presented hereinbelow, the peak intensity of the Raman spectral band in the approximate range from 1080 cm⁻¹-1150 cm⁻¹ decreases relative to the peak intensity of the Raman spectral band in the approximate range from 900 cm⁻¹-1000 cm⁻¹as the CTE of a titania-silica (doped or undoped) glass increases. Conversely, the peak intensity of the Raman spectral band in the approximate range from 1080 cm⁻¹-1150 cm⁻¹ increases relative to the peak intensity of the Raman spectral band in the approximate range from 900 cm⁻¹-1000 cm⁻¹ as the CTE of a titania-silica (doped or undoped) glass decreases. In one embodiment, a ratio of the peak intensity of the Raman spectral band in the approximate range from 1080 cm⁻¹-1150 cm⁻¹ to the peak intensity of the Raman spectral band in the approximate range from 900 cm⁻¹-1000 cm⁻¹ is correlated to a thermal property (e.g. ΔL/L₀, CTE or CTE slope) of a titania-silica glass (doped or undoped).

The following examples illustrate a method of determining thermal expansion properties of a material using an optical technique. In particular, Raman spectroscopy is used to determine ΔL/L₀ for a several doped and undoped titania-silica glasses. The examples are intended to be illustrative and not limiting of the scope of application of the present methods.

### EXAMPLE 1

This example describes the determination of a calibration curve that correlates Raman spectral features of a series of boron-doped titania-silica glass samples with CTE. To develop the correlation, CTE and CTE slope for each of the samples were measured independently by the sandwich seal technique. The sandwich seal technique uses birefringence to determine CTE and/or CTE slope of a sample relative to a known standard. The standard is placed between two pieces of the sample to form a “sandwich seal” that is used in the measurement. A circularly polarized beam is directed to the sandwich seal. Differences in thermal expansion of the samples relative to the standard lead to strains that produce a birefringence effect. From the birefringence measurement, the strains can be determined. The measurement is repeated at several temperatures to obtain birefringence as a function of temperature, which can be related to the temperature dependence of thermally-induced strains between the sample and standard and converted to CTE and/or CTE slope using the known CTE and/or CTE slope of the standard. The system used for the sandwich seal technique was operable over the temperature range from −75° C. to 150° C. Sample sizes up to about 3″×4″ could be accommodated in the sandwich seal system. Samples were kept at atmospheric pressure during the sandwich seal measurements. For a description of the sandwich seal technique, see K. E. Hrdina and C. A. Duran, Intl. J. Appl. Glass Sci. 5, 82-88 (2014).

Table 1 lists an identification number, composition, CTE, and CTE slope for each of the samples.

TABLE 1

| | Composition (wt %) | | | CTE | CTE Slope |
|---|---|---|---|---|---|
| Sample | B₂O₃ | TiO₂ | SiO₂ | (ppb/K) | (ppb/K²) |
| 2-1 | 1.0 | 3.0 | 96.0 | 182.4 | 1.56 |
| 2-2 | 2.0 | 3.0 | 95.0 | 374.4 | 1.16 |
| 2-3 | 3.0 | 3.0 | 94.0 | 450.4 | 0.94 |
| 2-4 | 4.5 | 3.0 | 92.5 | 795.4 | 0.096 |
| 3-1 | 0.25 | 7.4 | 92.35 | −48.1 | 1.88 |
| 3-2 | 0.50 | 7.4 | 92.1 | −39.9 | 1.82 |
| 3-3 | 1.0 | 7.4 | 91.6 | −1.9 | 1.64 |
| 3-4 | 3.0 | 7.4 | 89.6 | 195 | 1.02 |
| 5-1 | 6.0 | 7.4 | 86.6 | 561 | 0.28 |
| 5-2 | 8.0 | 7.4 | 84.6 | 792 | −0.14 |

Titania-silica soot was used in the preparation of all samples. The titania-silica soot was prepared by flame combustion of a titania precursor (tetraisopropoxide titanium) and a silica precursor (octamethyltetrasiloxane) in an oxidizing flame. The amount of titania precursor employed was adjust to provide titania-silica soot products having the TiO₂ concentrations listed in Table 1. The soot products had a uniform surface area and a uniform TiO₂ content.

Samples 3-1, 3-2, 3-3, and 3-4 were prepared by the sol-gel method. A sol was formed by mixing the soot with a strong base in water and stirring to eliminate agglomerations. A dopant precursor solution was added to the soot sol to provide boron for the composition. Boric acid was used as the boron doping precursor and was dissolved in an aqueous solution of TMAH (tetramethyl-ammonium hydroxide). The concentration of the boric acid was adjusted to achieve the concentrations of B₂O₃ listed in Table 1. To promote stability of the sol, the pH was maintained at 12 or greater. Since boric acid reacts with TMAH and the reaction of TMAH lowers the pH of the sol, the amount of TMAH was increased when incorporating higher concentrations of boric acid in the dopant precursor solution. The TMAH concentration in the dopant precursor solution for Samples 3-1, 3-2, 3-3, and 3-4, respectively was 3.3 wt %, 5.5 wt %, 7.6 wt %, and 8.7 wt %. The resulting sol was mixed by hand to provide a uniform slurry having a smooth, paint-like consistency and appearance. The slurry was rolled on a roller mill overnight to minimize agglomerations and increase homogeneity.

In the gelling phase, a gelling agent was added to the mixed slurry. The gelling agent reacted with hydroxyl groups, lowered pH, and neutralized some of the surface charge on the particles. Many compounds can be used as the gelling agent (see, for example, U.S. Pat. No. 6,209,357). For Samples 3-1, 3-2, 3-3, and 3-4, a solution of 75 wt % 1-chloro-2-propanol and 25 wt % 2-chloro-1-propanol was used as the gelling agent. The gelling agent was added to the mixed slurry such that the weight ratio of gelling agent to solvents (water and TMAH) was 0.0375:1. The mixture was degassed by first vigorously shaking the mixture for 1 minute and then placing the mixture in an open container in a vacuum chamber and reducing the pressure to 50 Torr to draw entrapped air from the mixture. The entrapped air was visible as bubbles emanating from the solution and degassing was continued until no noticeable bubble formation occurred in the mixture. The degassed slurry was then removed from the vacuum chamber and poured into molds to gel. The molds were placed in a humidity chamber kept at 90% relative humidity and gelling was allowed to proceed for two days. After gelling, the samples were dried to remove water and residual organic compounds. The gelled samples were dried by placing the molds in a fume hood and closing the sash. The molds were partially covered to control the rate of drying. Drying was allowed to proceed for about two days, at which time the covers were removed from the molds and the samples were allowed to continue drying at room temperature. The weight of the samples before and after drying was monitored. When the sample weight decreased to 70% or less of the initial weight (in the sol state), the sample was dried in an oven. The oven temperature was ramped from room temperature to 120° C. over a time period of 24 hours, the sample was held at 120° C. for two hours, and the temperature was decreased back to room temperature in 30 minutes.

After drying the samples were heated to 800° C. in air to burn off residual organic matter. The heating schedule was heating from room temperature to 120° C. at a rate of 30° C./hour, holding at 120° C. for seven hours, heating from 120° C. to 550° C. at the rate of 6° C./hour, heaging from 550° C. to 800° C. at a rate of 60° C./hour, holding at 800 for 30 minutes and cooling to room temperature at the natural furnace cooling rate. After burn off, the samples were consolidated at 1670° C. using the following schedule: heating from room temperature to 1100° C. at a rate of 6 ; holding at 1100° C. for 90 minutes; heating from 1100° C. to 1535° C. at a rate of 4° C./minute; holding at 1535° C. for 30 minutes; heating from 1535° C. to 1620° C. at a rate of 10° C./minute; heating from 1620° C. to 1670° C. at a rate of 5° C./minute; holding at 1670° C. for 60 minutes; and cooling at that natural furnace cool rate. Steps performed up to 1535° C. were performed in flowing He (5 slpm). Steps performed at or above 1535° C. were performed in flowing Ar (2 slpm). The consolidated samples were then annealed in 2 slpm of flowing N₂ according to the following procedure: heating from room temperature to 1050° C. in 90 minutes; holding at 1050° C. for 60 minutes; cooling 1050° C. to 700° C. at the rate of 3° C./hour; cooling from 700° C. to room temperature at the slower of the natural cooling rate or 5° C./minute.

The remaining samples were prepared by a spray drying process. A boron precursor (ammonium pentaborate tetrahydrate) was dissolved in water. The titania-silica soot was added to the solution to form a slurry (25% solids loading) and the slurry was spray dried to obtain a boron-doped titania-silica powder. The powder was pressed to form pellets having a thickness of 0.75 inches and lateral dimensions of 2 inches×3 inches or 3 inches×4 inches. The pellets were pre-sintered at 800 and consolidated at 1670° C. for one hour in flowing He (5 slpm). The consolidated pellets were annealed by heating to 1000° C. and cooling from 1000° C. to 700° C. at a rate of 3° C./hr.

Raman spectra over the range from 10 cm⁻¹-2000 cm⁻¹ were obtained at room temperature for each of the samples. The Raman spectra were acquired by measuring light scattered from each of the samples. The Raman excitation wavelength was 514 nm and was provided by Ar⁺ laser.

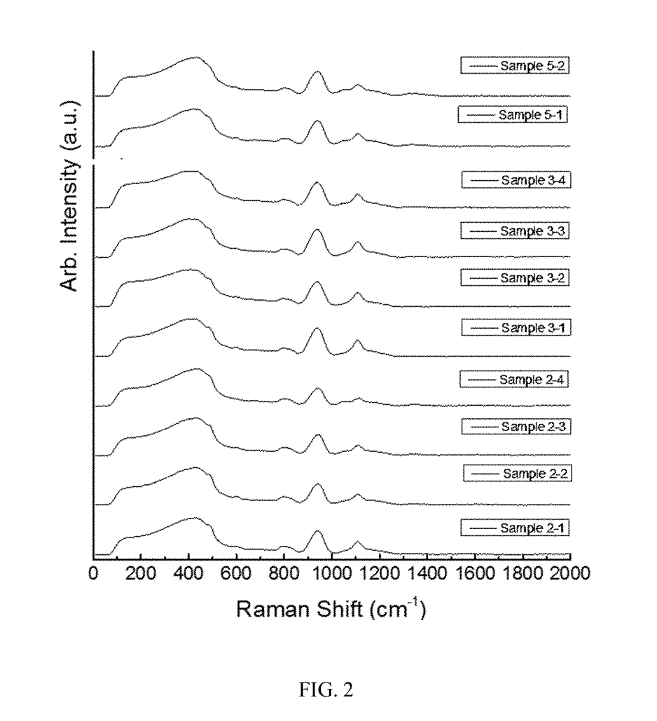

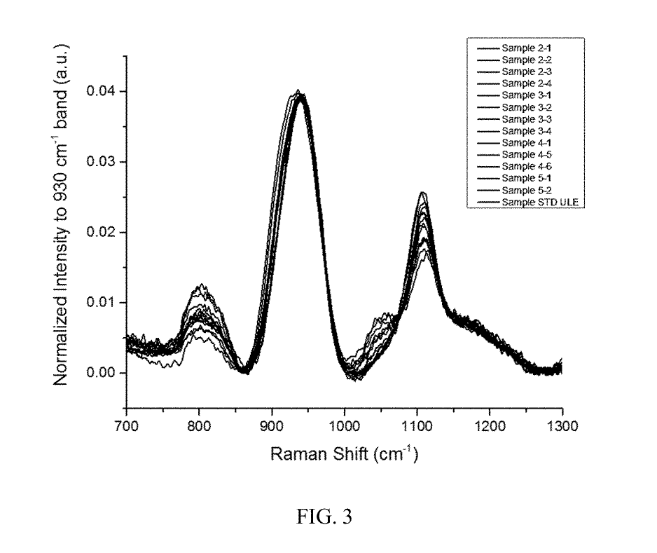

The Raman spectra of the samples are shown in FIG. 2. The bands having peak intensities at approximately 930 cm⁻¹ and 1110 cm⁻¹ are of interest in developing a CTE correlation. These bands may be referred to herein as the 930 cm⁻¹ band and the 1110 cm⁻¹ band, respectively. FIG. 3 shows an enlargement of the spectral range from 700 cm⁻¹ and 1300 cm⁻¹ to better illustrate the 930 cm⁻¹ and 1110 cm⁻¹ bands. The spectra shown in FIG. 3 have been corrected by subtracting background intensity and normalized to the peak intensity of the 930 cm⁻¹ band. Normalization facilitates comparison of the ratio of the peak intensity of the 1110 cm⁻¹ band (I₁₁₁₀) to the peak intensity of 930 cm⁻¹ band (1₉₃₀). Samples 4-1, 4-5, and 4-6 shown in FIG. 3 had a titania content of 11 wt % and were not analyzed further because they exhibited nucleation of a crystalline phase in the heat treatment steps of sample preparation.

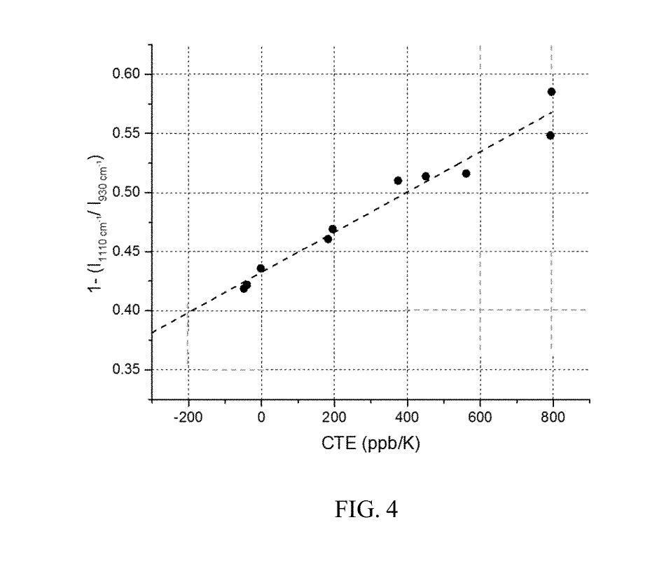

Consideration of the ratio I₁₁₁₀/I₉₃₀ indicates that as the CTE of the glass increases, the ratio I₁₁₁₀/I₉₃₀ decreases. FIG. 4 shows a correlation between the quantity 1-I₁₁₁₀/I₉₃₀ and CTE for the samples listed in Table 1 where I₁₁₁₀ and I₉₃₀ are obtained from the Raman spectra shown in FIG. 3. Data points for each sample are labeled with the identification number listed in Table 1. The results shown in FIG. 4 reveal a nearly linear correlation of the quantity 1-I₁₁₁₀/I₉₃₀ with CTE. The correlation permits determination of the CTE of unknown samples from measurements of Raman spectra.

This example shows that a thermal property of a material can be correlated with the intensity of light scattered from the material. This example further shows that a thermal property of a material can be correlated with features of Raman spectral bands of the material. This example also shows that CTE of a material can be correlated with the intensity of light scattered from the material or features of Raman spectral bands of the material.

### EXAMPLE 2

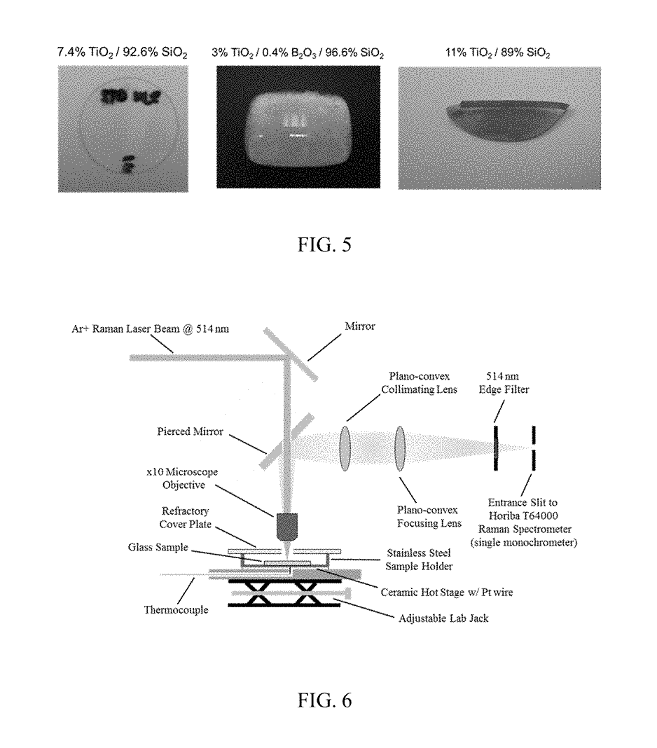

This example presents a correlation of features of the Raman spectra of materials with the relative length change (ΔL/L₀) of the material as a function of temperature. Three samples having the compositions listed in Table 2 were investigated. Images of the samples are shown in FIG. 5.

TABLE 2

| | Composition (wt %) | | |
|---|---|---|---|
| Sample | B₂O₃ | TiO₂ | SiO₂ |
| A | 0.4 | 3.0 | 96.6 |
| B | 0 | 7.4 | 92.6 |
| C | 0 | 11.0 | 89.0 |

Samples A and C were prepared by the sol-gel method using the method described above. Sample B was a commercial ULE (ultralow low expansion) glass available from Corning, Inc. (Product No. 7972). Sample B was prepared by a flame combustion process using OMCTS (octamethylcyclo-octatetraene) as a silicon precursor and Ti(OC₃H₈)₄ as a titanium precursor. The flame combustion process is described in U.S. Pat. No. 5,970,751. Preparation of Sample B included an annealing process that included the following steps: heating from room temperature to 990° C. at 20° C./hr; holding at 990° C. for 10 hr; cooling from 990° C. to 850° C. at 3° C./hr; cooling from 850° C. to 100° C. at 25° C./hr; and cooling from 100° C. to room temperature at an arbitrary rate.

Temperature dependent Raman spectra of the three samples were obtained using the micro-Raman system shown in FIG. 6. A 514 nm beam from an Ar⁺ laser was directed to a sample by a mirror through a pierced mirror and a 10× microscope objective. Scattered light from the sample was reflected by the pierced mirror through collimating optics and a 514 nm edge filter to the entrance slit of a Raman spectrometer, which resolved the scattered light and directed it to a CCD detector to record the Raman spectrum. Heating of the samples was accomplished with a ceramic hot stage positioned adjacent the samples. The stage included a ceramic block with a hole containing a Pt wire encompassed by an Al heat sink. The ceramic heater was operated via an external controller coupled to a thermocouple that was in contact with the bottom of the stainless steel sample holder.

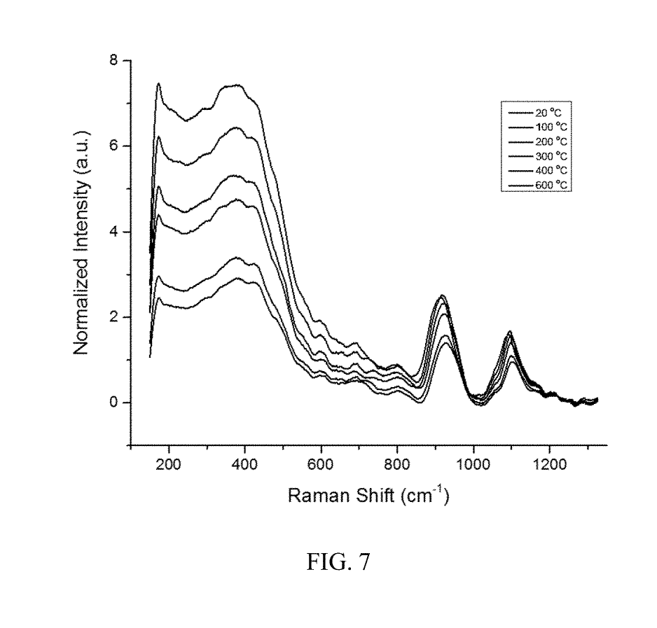

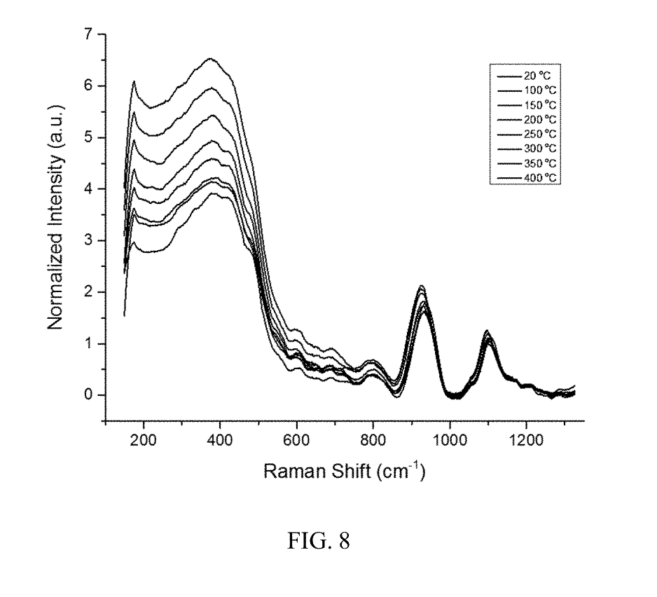

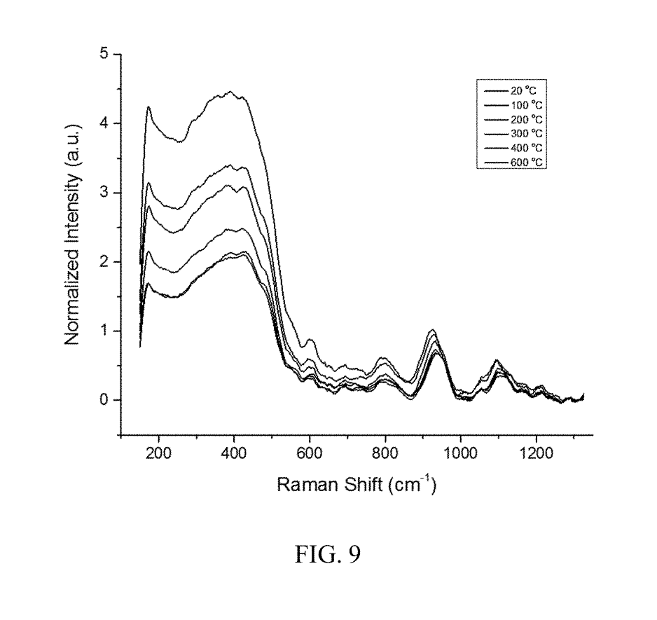

Raman spectra obtained at various temperatures for Samples A, B, and C are shown in FIGS. 7, 8, and 9, respectively. For each temperature, the sample was held for 30 minutes before measuring the Raman spectrum to ensure equilibration. The Raman spectra are normalized to the energy of the laser and are arranged in order of increasing temperature. The temperatures are indicated in the inset of each figure. The 930 cm⁻¹ and 1110 cm⁻¹ bands are evident in the spectra.

Another feature evident in each of FIGS. 7-9 is an overall increase in the spectral intensity in the range from 150 cm⁻¹-800 cm⁻¹. The increase in intensity in this range is due to thermal population of higher order phonon states. In order to obtain a direct comparison of the spectra at different temperatures, a thermal normalization of the spectra was completed. A Bose-Einstein thermal normalization technique was employed. The technique normalizes Raman spectra by the thermal population of phonon states. The thermal population of phonon states is frequency dependent and can be described by the following thermal normalization parameter:

$$R ( ω ) = {I}_{exp} ( ω ) \frac{ω}{( n + 1 ) {( {ω}_{0} - ω )}^{4}} where$$

$$n = {[ exp ( \frac{ℏ ω}{{k}_{B} T} ) - 1 ]}^{- 1}$$

In the equations above, R(ω) is the thermally normalized frequency dependent intensity, ω is the Raman shift (cm⁻¹), ω₀ is the frequency of laser light (19,436 cm⁻¹ for 514 nm), Iₑₓₚ(ω) is the experimental spectrum, n is the Bose-Einstein factor, h is the Plank constant, k_{B} is the Boltzmann constant, and T is the absolute temperature of the measurement.

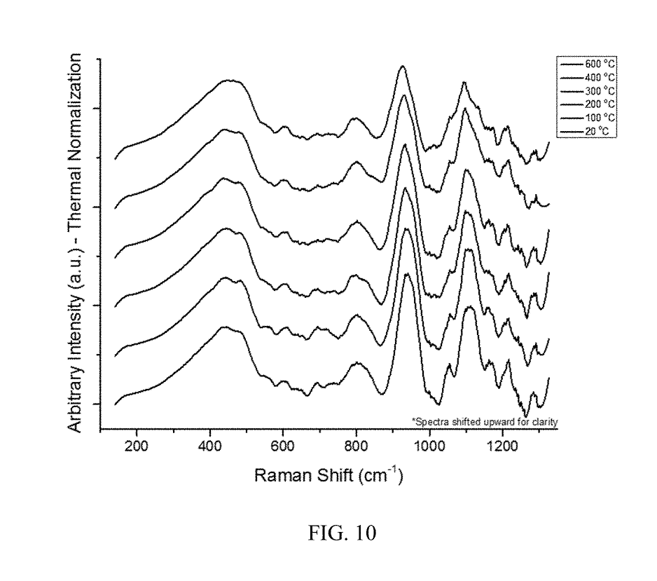

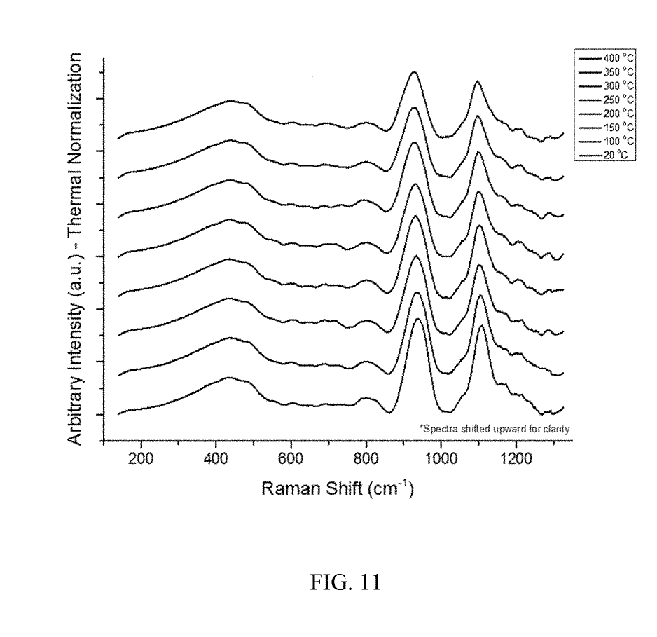

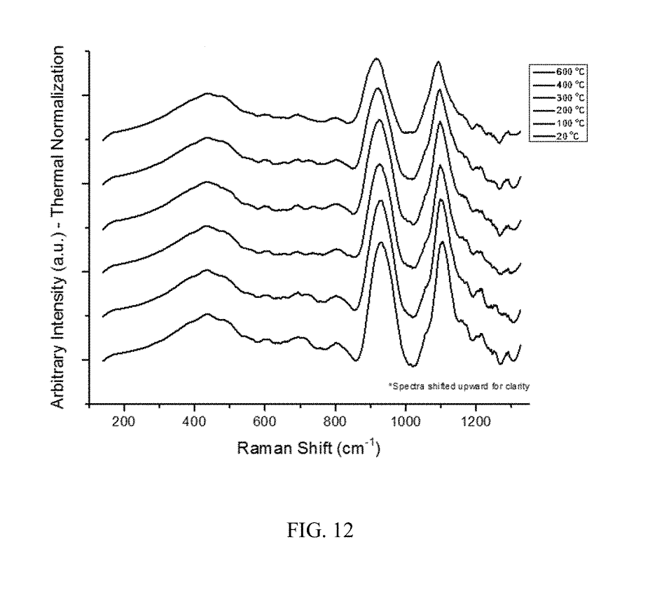

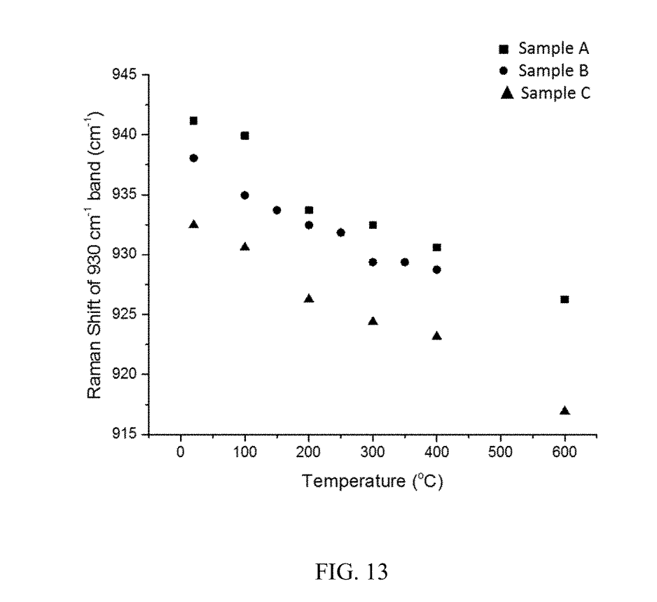

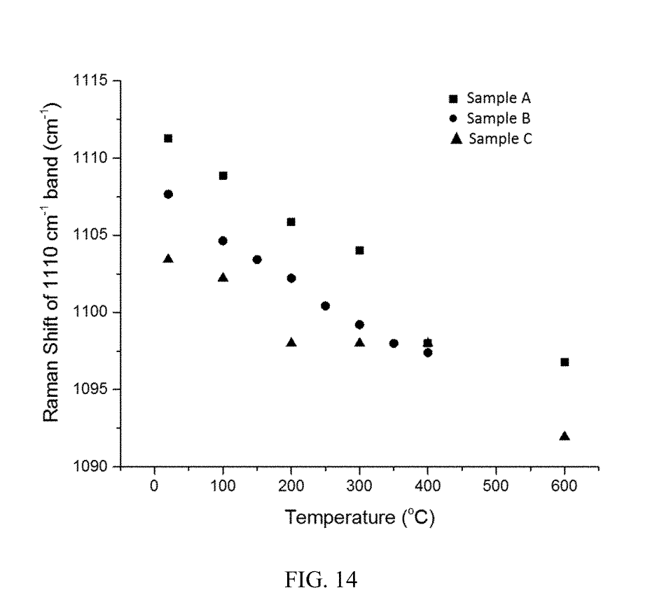

FIGS. 10-12 depict thermally normalized versions of FIGS. 7-9, respectively, for Samples A, B, and C. The spectra have been displaced vertically in ascending order of increasing temperature to more clearly illustrate variations in the features of the 930 cm⁻¹ and 1110 cm⁻¹ bands. The thermally normalized spectra indicate that the 930 cm⁻¹ and 1110 cm⁻¹ bands shifted to lower frequency with increasing temperature for all three samples (FIGS. 13 and 14).

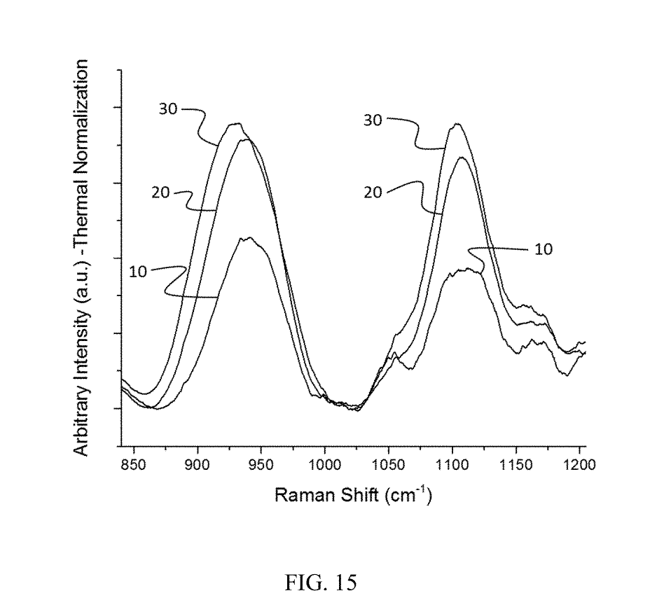

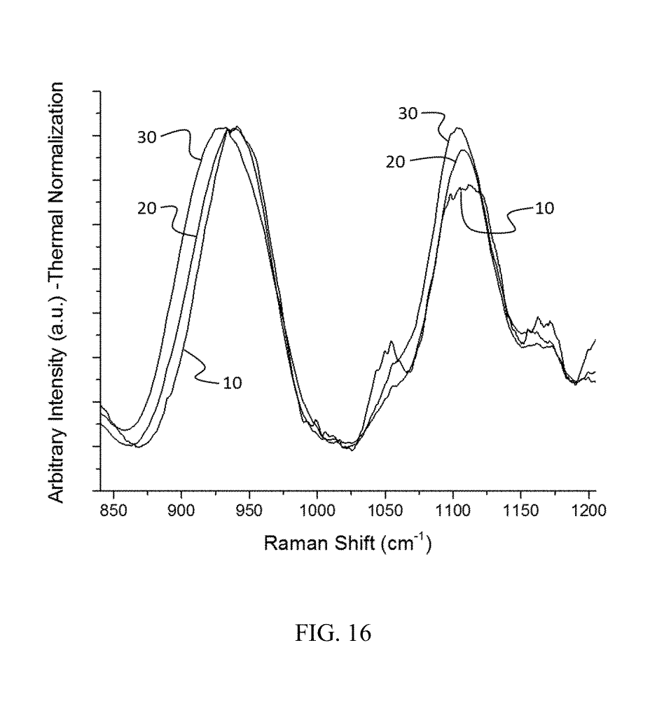

FIG. 15 shows an enlargement of the Raman spectrum at room temperature in the range from 850 cm⁻¹-1200 cm⁻¹. The spectra of Samples A, B, and C are labelled “10”, “20”, and “30”, respectively. The spectra indicate that the peak intensities of the 930 cm⁻¹ and 1110 cm⁻¹ bands increase with increasing TiO₂ content. FIG. 16 is a modification of FIG. 15 in which the spectra are normalized to the intensity of the 930 cm⁻¹ band. FIG. 16 shows that the peak intensity ratio I₁₁₁₀/I₉₃₀ increases with increasing TiO₂ content.

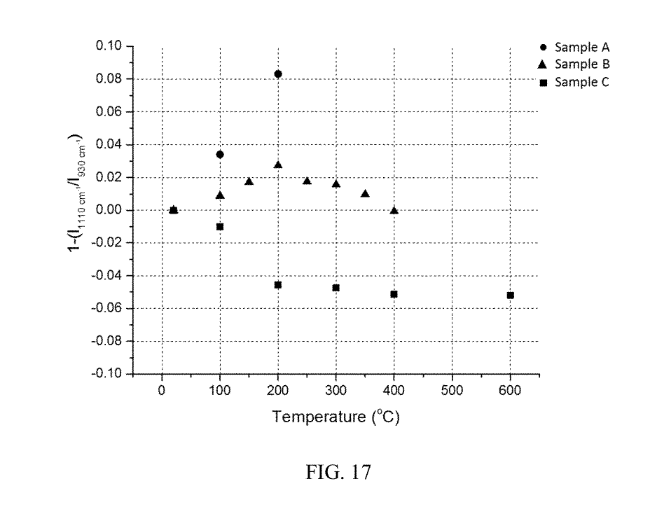

Spectra of the type shown in FIG. 16 were obtained for each sample from the thermally normalized spectra shown in FIGS. 10-12. The peak intensity ratio I₁₁₁₀/I₉₃₀ was obtained for each sample as a function of temperature. FIG. 17 shows the variation in the parameter 1-I₁₁₁₀/I₉₃₀ with temperature. The data for Sample A was truncated at 200° C. because increased overlap of a boron-related Raman band near 1100 cm⁻¹ with the 1110 cm⁻¹ band with increasing temperature prevented unambiguous resolution of I₁₁₁₀. The noteworthy feature of the data shown in FIG. 17 is its strong similarity to the relative length change (ΔL/L₀) data shown in FIG. 1. Compare the data for Samples A, B, and C in FIG. 17 with curves 1, 2′, and 3, respectively.

This example demonstrates that Raman spectral data provide a reliable correlation of the relative length change (ΔL/L₀).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

What is claimed is:

1. A method of characterizing a glass comprising:
detecting light scattered from a glass; and
determining a thermal property of said glass from said scattered light.

2. The method of claim 1, wherein said detecting scattered light includes directing a laser at said glass.

3. The method of claim 1, wherein said detecting scattered light includes determining the Raman spectrum of said glass, said Raman spectrum including one or more bands.

4. The method of claim 3, wherein said Raman spectrum is determined over a range from 850 cm⁻¹ to 1200 cm⁻¹.

5. The method of claim 3, wherein said Raman spectrum is determined at a plurality of temperatures.

6. The method of claim 5, wherein said plurality of temperatures includes a temperature above 100° C.

7. The method of claim 3, wherein said determining thermal property includes determining the peak intensity of a first Raman band.

8. The method of claim 7, wherein said peak intensity of said first Raman band has an energy in the range from 1050 cm⁻¹-1200 cm⁻¹.

9. The method of claim 7, wherein said determining thermal property further includes determining the peak intensity of a second Raman band.

10. The method of claim 9, wherein said peak intensity of said second Raman band has an energy in the range from 900 cm⁻¹-1000 cm⁻¹.

11. The method of claim 9, wherein said determining thermal property includes calculating a ratio of said peak intensity of said first Raman band to said peak intensity of said second Raman band.

12. The method of claim 7, wherein said peak intensity of said first Raman band is determined at a plurality of temperatures.

13. The method of claim 1, wherein said glass comprises TiO₂.

14. The method of claim 1, wherein said detecting scattered light includes detecting said scattered light at a plurality of temperatures.

15. The method of claim 1, wherein said thermal property is the coefficient of thermal expansion of said glass.

16. The method of claim 1, wherein said thermal property is the relative length change ΔL/L₀ of said glass.

17. A method of characterizing a material comprising:
correlating a spectroscopic property of a material with a thermal property of said material.

18. The method of claim 17, wherein said spectroscopic property includes intensity of scattered light.

19. The method of claim 18, wherein said thermal property is the relative length change ΔL/L₀ or coefficient of thermal expansion of said material.
